(19) United States
(12) Patent Application Publication
(10) Pub. No.: US 2003/0223583 A1
(43) Pub. Date: Dec. 4, 2003

(54) Secure data content delivery system for multimedia applications utilizing bandwidth efficient modulation

(75) Inventors: Charles F. Stirling, Rancho Palos Verdes, CA (US); Bernard M. Gudaitis, Palos Verdes Estates, CA (US); William G. Connelly, Vista, CA (US); Catherine C. Girardey, Palos Verdes Estates, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/422,113

(22) Filed: Apr. 24, 2003

Related U.S. Application Data
(60) Provisional application No. 60/376,105, filed on Apr. 29, 2002.
(60) Provisional application No. 60/376,243, filed on Apr. 29, 2002.

(51) Int. Cl. H04N 7/167

(52) U.S. Cl. 380/216

(57) ABSTRACT

An apparatus and method for delivering multimedia content for public presentation is disclosed. An exemplary system includes a distribution entity transmitting content data to at least one user system for receiving the transmitted content data and presenting for exhibition and a network operation center for coordinating encryption of the transmitted content data at the distribution entity and decryption of the transmitted content data at the user system. The content data is transmitted using one or more bandwidth efficient modulation (BEM) techniques selected from the group comprising forward error control coding, pulse shaping, adaptive receive equalization, nonlinear predistortion and linear predistortion.

### CROSS-REFERENCE TO RELATED APPLICATIONS

This application claims the benefit under 35 U.S.C. §119(e) of the following co-pending U.S. provisional patent applications, which are incorporated by reference herein:

U.S. Provisional Application Serial No. 60/376,105, filed Apr. 29, 2002, Charles F. Stirling, Bernard M. Gudaitis, William G. Connelly and Catherine C. Girardey, entitled “SECURE DATA CONTENT DELIVERY SYSTEM FOR MULTIMEDIA APPLICATIONS UTILIZING BANDWIDTH EFFICIENT MODULATION”; and

U.S. Provisional Patent Application Serial No. 60/376,243, filed Apr. 29, 2002, by inventors Bernard Mark Gudaitis and William G. Connelly, entitled ARCHITECTURE CONTAINING EMBEDDED COMPRESSION AND ENCRYPTION ALGORITHMS WITHIN THE DATA FILE, attorneys' docket number G&C 147.0096-US-P1.

This application is related to the following co-pending and commonly-assigned U.S. patent applications, which are all incorporated by reference herein:

U.S. Utility patent application Ser. No. 10/178,602, filed Jun. 24, 2002, by inventor Michael A. Enright, METHOD AND APPARATUS FOR DECOMPRESSING AND MULTIPLEXING MULTIPLE VIDEO STREAMS IN REAL-TIME, attorneys' docket number G&C 147.0080-US-U1, which claims the benefit of U.S. Provisional Patent Application Serial No. 60/376,254, filed Apr. 29, 2002, by inventor Michael A. Enright, entitled METHOD TO DECOMPRESS AND MULTIPLEX MULTIPLE VIDEO STREAMS IN REAL-TIME, attorneys' docket number G&C 147.0080-US-P1;

U.S. Provisional Patent Application Serial No. 60/376,254, filed Apr. 29, 2002, by inventor Michael A. Enright, entitled METHOD TO DECOMPRESS AND MULTIPLEX MULTIPLE VIDEO STREAMS IN REAL-TIME, attorneys' docket number G&C 147.0080-US-P1;

U.S. Provisional Patent Application Serial No. 60/376,087, filed Apr. 29, 2002, by inventor Mary A. Spio, entitled METHODOLOGY FOR DISPLAY AND DISTRIBUTION OF LIVE CINEMA GRADE CONTENT IN REAL TIME, attorneys' docket number G&C 147.0081-US-P1;

U.S. Utility patent application Ser. No. 10/289,043, filed Nov. 6, 2002, by inventors Andrew Strodtbeck and Susan Bach, entitled PREDISTORTED MODULATION SYSTEM FOR BANDWIDTH EFFICIENT SATELLITE LINKS, attorneys' docket number G&C 147.0089-US-U1, which claims the benefit of U.S. Provisional Patent Application Serial No. 60/376,214, filed Apr. 29, 2002, by inventors Andrew Strodtbeck and Susan Bach, entitled PREDISTORTED MODULATION SYSTEM FOR BANDWIDTH EFFICIENT SATELLITE LINKS, attorneys' docket number G&C 147.0089-US-P1;

U.S. Provisional Patent Application Serial No. 60/376,382, filed Apr. 29, 2002, by inventor Keith Jarett, entitled HYBRID TDMA/FDM UPLINK FOR SPOT-BEAM COMMUNICATION SYSTEM, attorneys' docket number G&C 147.0092-US-P1;

U.S. Utility patent application Ser. No. 10/______, filed Feb. 13, 2003, by inventor Keith Jarrett, entitled SYSTEM AND METHOD FOR MINIMIZING INTERFERENCE IN A SPOT BEAM COMMUNICATIONS SYSTEM, attorneys' docket number G&C 147.0093-US-U1, which claims the benefit of U.S. Provisional Patent Application Serial No. 60/376,239, filed Apr. 29, 2002, by inventor Keith Jarrett, entitled C/I MINIMIZATION FOR SPOT BEAM COMMUNICATION SYSTEM, attorneys' docket number G&C 147.0093-US-P1; and

U.S. Provisional Patent Application Serial No. 60/376,244, filed Apr. 29, 2002, by inventors Ismael Rodriguez and James C. Campanella, entitled METHOD TO SECURELY DISTRIBUTE LARGE DIGITAL VIDEO/DATA FILES WITH OPTIMUM SECURITY, attorneys' docket number G&C 147.0101-US-P1.

### BACKGROUND OF THE INVENTION

1. Field of the Invention

The present invention relates to systems and methods for transmitting cinema grade video content. Particularly, this invention relates to transmitting cinema grade video content to multiple theater exhibitors in an intangible medium such as satellite or fiber optic cable.

2. Description of the Related Art

Presently, movies are produced and distributed to theaters on a physical film that is distributed by ground/air transport. This delivery method is relatively expensive and contains reliability risks. The business case to support satellite transmission of digital movie files has not been established because the time required for transport is generally very long relative to the length of the movie using conventional modulation schemes (e.g., BPSK and QPSK).

Bandwidth efficient modulation (BEM) techniques, which yield greater than one effective bit per Hz per sec or one sample per Hz, are available over satellites today in limited applications where very large transmit and receive antenna apertures are allowed. However, this will not be the case for the receive antennas on most urban theaters. Using lower order modulations (e.g., QPSK) with smaller aperture receive antennas (<2 m) results in higher transport costs (e.g., cost per unit transponder time) than would be the case when BEM technology is applied. In addition, the higher data rates achieved by BEM capability enables live streaming of high definition, cinema quality content to offer the exhibitors additional revenue sources.

The transmission of large electronic files will provide the cinema distribution industry with an alternative means of global delivery. A fundamental problem is that existing satellite transponder capability severely constrains the delivery efficiency. Therefore, cost effective digital cinema transmission over satellites has been limited due to these data rate throughput restrictions.

Accordingly, there is a need for systems and methods for combining and delivering cinema quality digital presentations to theater venues in a cost effective manner. There is also a need for such systems and methods to enable such transmitted events in a secure manner. Finally, there is a need for such systems to operate in a bandwidth efficient manner. As detailed hereafter, the present invention meets these needs.

### SUMMARY OF THE INVENTION

The use of bandwidth efficient modulation (BEM) techniques enables real-time large file transport over existing satellite transponders with small aperture (approximately 1 to 2 m) receive antennas. The efficient handling of large volumes of information traffic in the form of films and real-time alternate (live) high definition (HD) content without resorting to large aperture receive antennas is therefore a major discriminant of this invention.

The demand for increased system capacity translates into the need for higher individual data rates and wider transmission bandwidths. The required transmission bandwidths can, however, become larger than the allocated frequency bands available on existing satellite transponders without the use of bandwidth efficient modulation (BEM). The use of high order BEM formats, such as 16-QAM (quadrature amplitude modulation), offers a solution to this problem. High order BEM formats, however, are very sensitive to channel and other distortions. Therefore, the use of such high order BEM techniques requires a unique understanding of the sources of distortions (e.g., RF mismatches, band limiting, poor isolation, etc.) and how to eliminate them and how to mitigate unavoidable sources of distortion (e.g., satellite non-linearities, noise, channel distortion), through test, simulation, and analysis. This technical capability is therefore necessary to provide efficient real-time transmission of digital cinema files over satellites to small aperture receive antennas.

A typical embodiment of the present invention provides a secure data content delivery service to the motion picture studios for electronic distribution of feature movies to the theaters. These movies, in digital format, are distributed securely via satellite broadcast and/or high-speed fiber optic network. A single movie can be simultaneously broadcast to thousands of theaters worldwide. The customers are the studios since this service reduces their distribution cost. In addition, the theaters are important to the extent they must include the equipment to receive and display digital movies on the screen. In addition, the theaters can have the flexibility of showing alternate content such as live events and HD video advertising.

A movie shot on conventional 35 mm film can be telecined to digital HD and stored on disk or tape media. In this post production process, color correction is applied to the digital images in order to create the proper “look” for the movie. In addition, the movie file is compressed and encrypted on the storage media. The movie may also be shot with a digital camera and recorded to disk or tape, and in a similar manner, color correction, compression, and encryption are applied to the movie file. Some material, e.g., trailers and advertisements, will be inserted at the theater just prior to exhibition. At current resolution formats (1-2 Megapixels), typical movie files (e.g., a two hour movie) are on the average 50 Gbytes compressed. The digital movie can be transported to a Network Operations Center (NOC) via OC-3 fiber optic cable or ground transportation (e.g., via a parcel delivery service) where it is stored and formatted for distribution to the theaters. Primary distribution to the theaters can be via satellite multi-cast. However, terrestrial distribution, such as via OC-3 fiber optic cable, is also an option.

The movie is received by the theaters and stored on a secure server. The server manages the distribution of the movies via fast Ethernet to the specified screen projectors. As the movie is shown, information such as the number of showings and show times by screen are collected and transmitted back to the NOC where it is processed and formatted and provided to the studios as part of the service. Once the run end date for the movie is reached, as specified by the contract between the studio and theater, it can be automatically and permanently deleted from the theater server.

The present invention integrates BEM modulation techniques to reduce the non-linear effects in a geosynchronous satellite link coupled with a small aperture receive antenna to provide data rates sufficient to economically transport very large files (approximately 60 Gb or greater) in real time through existing satellite transponders. The combination of these capabilities provides a solution to the business case enabling economic use of satellite transmission for theatrical distribution of cinema grade film and live alternate content.

This application of BEM technology to a digital film file transport significantly increases the efficiency with which such files will be transported over satellites. BEM provides technologies needed to utilize existing satellite data processing systems and transponders can meet near term demands for higher-data-rate systems, such as film and live streaming file transport. BEM can initially provide a full rate 1 sample/symbol digital modulator and various 8- and 16-ary modulation schemes to determine the optimal 2-3 bps/Hz approach to support various multimedia applications.

In addition, BEM technology in a cinema system can be further evolved to include an encoder and decoder for a 3 bps/Hz forward error correcting (FEC) code, a binary correlator that enables the carrier recovery loop in high order modulation systems to lock without the use of a×4 multiplication, enabling a more robust method of carrier recovery for BEM systems, frequency domain equalization as a possible replacement/adjunct to time-domain equalization for performance enhancement or simplified (lower cost) implementation and a 16 QAM modem to ensure timely acquisition of test data and validation of architecture trades.

A typical system or method of the present invention comprises a distribution entity transmitting a content data (such as a video data), at least one user system (such as an exhibitor system) for receiving the transmitted content data and presenting for exhibition and a network operation center for coordinating encryption of the transmitted content data at the distribution entity and decryption of the transmitted content data at one or more user systems. The content data is transmitted using one or more bandwidth efficient modulation (BEM) techniques selected from the group comprising forward error control coding, pulse shaping, adaptive receive equalization, nonlinear predistortion and linear predistortion. The content data can be transmitted via satellite broadcast to more than one user system and the content data can be transmitted via satellite at a data rate sufficient to allow the content data to be played at one or more user systems in real time. Typically, the content data comprises at least cinema quality video.

Some particular exemplary embodiments can utilize particular BEM techniques applied to different modulation schemes. Higher order modulation schemes generally require additional BEM techniques. For example, the content data can be transmitted via satellite using quadrature phase shift keying (QPSK) modulation and forward error control coding and pulse shaping BEM techniques. The content data can be transmitted via satellite using eight phase shift keying (8PSK) modulation and forward error control coding, pulse shaping and adaptive receive equalization BEM techniques. The content data can be transmitted via satellite using sixteen quadrature amplitude modulation (16QAM) (or any other four bit per symbol modulation scheme) and forward error control coding, pulse shaping, adaptive receive equalization and nonlinear predistortion BEM techniques. Alternately, the content data can be transmitted via satellite using sixty-four quadrature amplitude modulation (64QAM) (or any other six bit per symbol modulation scheme) and forward error control coding, pulse shaping, adaptive receive equalization and nonlinear and linear predistortion BEM techniques.

In further embodiments, the content data includes file encryption and conditional access encryption. A decryption key (or key component) for decrypting the video source is communicated to at least one user system from the network operation center. The conditional access encryption is decrypted before the content data is stored by at least one user system and the file encryption is decrypted after the content data is stored but before the content data is displayed by at least one user system.

A typical user system comprises a receiver for receiving and extracting video data from the transmitted content data, data storage for buffering the video data, a decryption unit for decrypting the video data, a decompression unit decompressing the video data and a display device for displaying the decrypted and decompressed video data.

The present invention can increase bandwidth (BW) efficiency by as much as 300%, reducing transit time and costs by approximately ⅔. Most important, this can be achieved without the need to increase the size of the receive antenna aperture, allowing use of unlicensed receive terminals.

### BRIEF DESCRIPTION OF THE DRAWINGS

Referring now to the drawings in which like reference numbers represent corresponding parts throughout:

FIGS. 1A and 1B depict a top-level functional block diagram of one embodiment of a media program distribution system; and

FIG. 2 is a functional block diagram of a computer system to perform the operations of the media preparation processor and processing system.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1.0 System Architecture

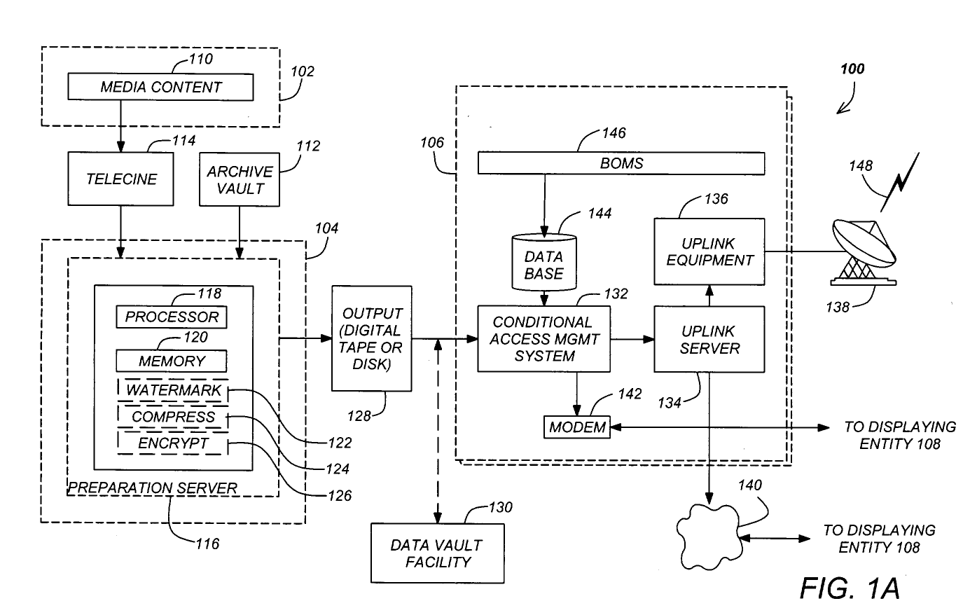

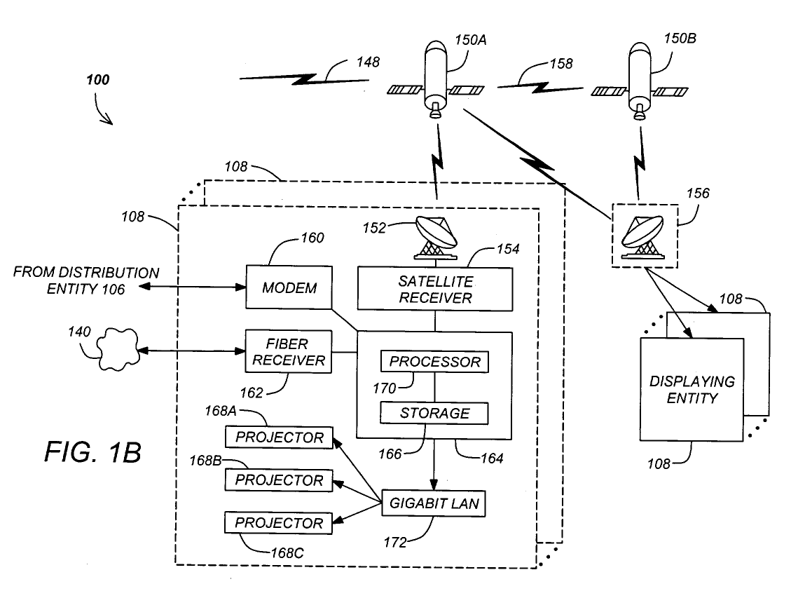

FIGS. 1A and 1B depict a top-level functional block diagram of one embodiment of a media program distribution system 100. The media distribution system 100 comprises a content provider 102, a protection entity 104, a distribution entity 106 (e.g., network operations center) and one or more presentation entities 108 (e.g,. displaying or exhibitor systems or user systems). The content provider 102 provides media content 110 such as audiovisual material to the protection entity 104. The media content 110, which can be in digital or analog form, can be transmitted in electronic form via the Internet, by dedicated land line, broadcast, or by physical delivery of a physical embodiment of the media (e.g., a celluloid film strip, optical or magnetic disk/tape). Content can also be provided to the protection entity 104 (also referred to as a preparation entity) from a secure archive facility 112.

The overall system can be viewed as three fundamental segments, the digital post production segment (including a processor 114 and a protection entity 104), the distribution entity 106 or network operations center (NOC), and the presentation entities 108 or in cinema systems. The system allows a great degree of flexibility in that components utilized within each of the three segments can be easily replaced. In addition, the system is compatible with various compression technologies, including MPEG2 and wavelet, and can accommodate various system security approaches. The system configuration and software script can be tailored to any compression technology. Similarly, the system architecture allows for multiple MPEG2 encoder vendors. The transport protocol is typically Internet protocol (IP) over digital video broadcasting (DVB). This format allows the flexibility to carry any type of data over the transmission. For example, the system can carry MPEG2 compressed video data, wavelet compressed video data or any other type of data. The format can also be compressed video directly over digital video broadcasting.

1.1 Post Production

The media content 110 may be telecined by processor 114 to format the media program as desired. For example, 35 mm film can be scanned by a SPIRIT telecine unit, the frames can be color corrected and the output stored on a server along with the audio, e.g. a SGI server. The telecine process can take place at the content provider 102, the protection entity 104, or a third party.

The protection entity 104 may include a media preparation processor 116. In one embodiment, the media preparation processor 116 includes a computer system such as a server, having a processor 118 and a memory 120 communicatively coupled thereto. The protection entity 104 further prepares the media content 110. Such preparation may include adding protection to the media content 110 to prevent piracy of the media content 110. For example, the preparation processor 116 can add watermarking 122 and/or encrypt 126 the media content 110 to protect it. In addition, the preparation processor can also apply compression 124 to the media content 110. Once prepared, the output media content 128 can be transferred to digital tape or a disk (e.g. a DVD, laserdisk, or similar medium). The output media content 128 can then be archived in a data vault facility 130 until it is needed.

For example, the post production processing can include producing an output tape (e.g., a high definition D5 tape) of the color corrected scanned film and audio from the SGI server. The image portion of the tape is input into a unit (e.g. a PANASONIC HD3700) to convert the video to HD-SDI SMPTE292. The audio portion of the tape is input into a DOLBY encoder to convert the audio to 608 BNC digital audio. Both the converted video and audio are then communicated to an encoder which encodes and compresses the video and audio to an MPEG2 or similar format. The MPEG2 files are then encrypted using a studio authorization token, i.e. encryption is controlled by the content owners. Upon successful authentication, the server encrypts the files, inserts an encrypted authorization header, generates an unencrypted playlist file and stores all files on one or more tapes, harddrives or other suitable digital storage medium (such as DLT tapes) as the prepared output media content 128. As an example, the content can be encoded and encrypted using an AVICA suite of equipment, which comprises a BARCONET encoder and a DATASTORE or EVS server or a GRASSVALLEY encoder/server. Here and throughout this document, the specific hardware elements are identified only for illustration; suitable alternate vendors hardware as well as later developed equipment can also be used.

After the compressed and encrypted content data is stored on one or more tapes or harddrives, it is then delivered to the NOC. The content data can be sent over a secure wide area network or similar transport or physically delivered to the NOC.

1.2 Network Operations

When needed, the prepared output media content data 128 is then provided to the distribution entity 106 (alternatively referred to hereinafter as the network operations center [NOC]). Although illustrated as separate entities, the protection entity 104 and the distribution entity 106 can be combined into a single entity, thus ameliorating some security concerns regarding the transmission of the output media content data 128.

In general, the NOC receives encoded and encrypted content data, distributes conditional access keys (or key components) to authorized receivers at the exhibitor systems, re-packages the content received from digital production and multicasts it to the receivers securely and reliably over a satellite link.

The distribution entity 106 includes a conditional access management system (CAMS) 132 (also referred to as a configuration management engine), that accepts the output media content data 128, and determines whether access permissions are appropriate for the content data 128. Further, CAMS 132 may be responsible for additional encrypting so that unauthorized access during transmission is prevented. Once the data is in the appropriate format and access permissions have been validated, CAMS 132 provides the output media content data 128 to an uplink server 134, ultimately for transmission by uplink equipment 136 to one or more displaying entities 108 (also referred to as exhibitor, cinema or user systems) (shown in FIG. 1B). This is accomplished by the uplink equipment 136 and uplink antenna 138. Also, as shown, in addition or in the alternative to transmission via satellite, the media program can be provided to the displaying entity 108 via a forward channel fiber network 140. Additionally, some low data rate information such as configuration commands to the exhibitor systems may be transmitted to displaying entity 108 via a modem 142 using, for example, a public switched telephone network line. A land based communication such as through fiber network 140 or modem 142 is referred to as a back channel. Thus, information can be transmitted to and from the displaying entity 108 via the back channel or the satellite network. Typically, the back channel provides data communication for administration functions (e.g. billing, authorization, usage tracking, etc.), while the satellite network provides for transfer of the output media content data 128 to the displaying entities 108.

The output media content data 128 may be securely stored in a database 144. Data is transferred to and from the database 144 under the control and management of the business operations management system (BOMS) 146. Thus, the BOMS 146 manages the transmission of information to the user systems 108, and assures that unauthorized transmissions do not take place. For example, once the DLT tape is received at the NOC, it is loaded onto the content archive server. The data is then transferred over an ETHERNET connection to a distribution server. The distribution server is responsible for multicasting the content reliably to the user systems 108. This involves two processes, initiating a multicast session and performing Forward Error Correction (FEC).

The distribution server first receives content from the content storage server in the form of IP datagrams. It then runs the Forward Error Correction (FEC) software application, e.g., FAZZT manufactured by Kencast Inc. (http://www.kencast.com). The FEC enables the receiver to reconstruct error-free files. It achieves this by transmitting additional redundant information that can be used at the receiving end to correct for errors anywhere in the files and to reconstruct the files.

Once processed at the distribution server, the data is sent to the Transmission Security (TRANSEC) Server (e.g. CypherCast manufactured by Irdeto (http://www.mindport.com)) for transmission link encryption. The transmission encryption layer is used o ensure that the content is received by intended recipients only. Only receivers with proper access (proper keys) are authorized to receive and are able to decrypt. Once encrypted at the TRANSEC Server, the data is then moved to the Internet protocol encapsulator (IPE).

The role of the IPE is to interface the IP-based network to the digital video broadcast (DVB) satellite network. The IPE is responsible for encapsulating the IP data into MPEG2 packets, and for generating the DVB transport stream. Once the data is encapsulated into an MPEG2/DVB compliant packet, it is transferred to the modulator. The IPE used in this exemplary architecture is the IP/DVB Encapsulator DBN-25 IP manufactured by SKYSTREAM (http://www.skystream.com).

Turning to FIG. 1B, the data transmitted via uplink 148 is received in a satellite 150A, and transmitted to a downlink antenna 152, which is communicatively coupled to a satellite or downlink receiver 154. For example, the MPEG/DVB transport stream is fed to a NEWTEC (http://www.newtec.be) Incognito Variable Rate DVB QPSK Modulator for conversion to an Intermediate Frequency (IF) of approximately 70 MHz. This 70 MHz stream is then upconverted and amplified to the appropriate RF frequency of the satellite transponder selected for use of broadcasting the signal to the downlink sites at the exhibitors. After frequency conversion and amplification, the signal is fed to a 3.8 m satellite antenna for uplink.

In one embodiment, the satellite 150A also transmits the data to an alternate distribution entity 156 and/or to another satellite 150B via crosslink 158. Typically, satellite 150B services a different terrestrial region than satellite 150A, and transmits data to the user systems 108 in other geographical locations.

1.3 Cinema Architecture

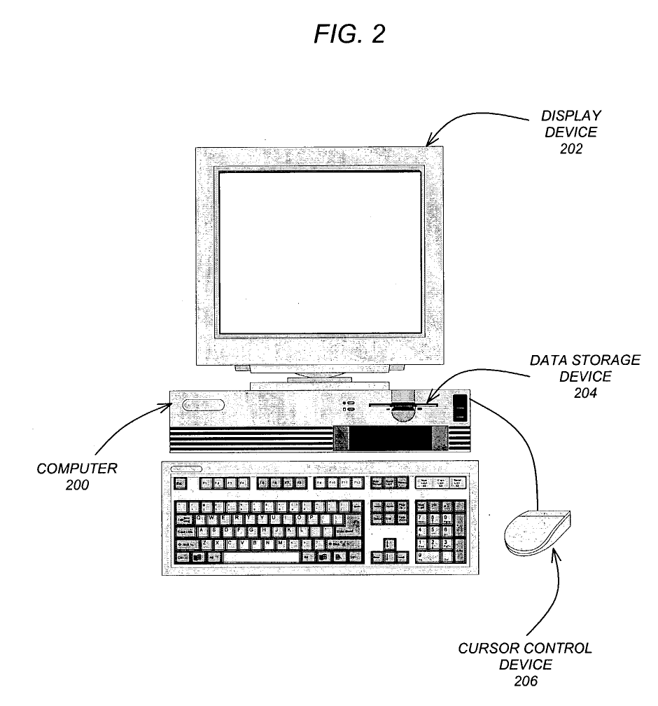

A typical user system or displaying entity 108 comprises a modem 160 (and may also include a fiber receiver 158) for receiving and transmitting information through the back channel (i.e., via an communication path other than that provided by the satellite system described above) to and from the distribution entity 106. For example, feedback information (e.g. relating to system diagnostics, billing, usage and other administrative functions) from the user system 108 can be transmitted through the back channel to the distribution entity 106. The output media content 128 and other information may be accepted into a processing system 164 (also referred to as a content server) such as a server or computer similar to that which is illustrated in FIG. 2 (see description below). The output media content data 128 may then be stored in the storage device 166 for later transmission to displaying systems (e.g., digital projectors) 168A-168C. Before storage, the output media content data 128 can be decrypted to remove transmission encryption (e.g. any encryption applied by the CAMS 132), leaving the encryption applied by the preparation processor 116.

The security for the content encryption (applied by the preparation processor 116) can be further enhanced by dividing the decryption key into multiple key components that enable the recreation of the original decryption key. For example, two software decryption components and one physical decryption component can be used at the user system. One of the software decryption components can be transmitted over satellite and the other transmitted over the back channel. The hardware decryption component can be stored in a hardware element plugged into the in-cinema equipment. The security system is detailed in U.S. Provisional Patent Application Serial No. 60/376,244, filed Apr. 29, 2002, by Ismael Rodriguez and James C. Campanella, entitled METHOD TO SECURELY DISTRIBUTE LARGE DIGITAL VIDEO/DATA FILES WITH OPTIMUM SECURITY, attorneys' docket number G&C 147.0101-US-P1.

When the media content 110 (e.g., video data) is to be displayed, final decryption techniques are used on the output media content 128 to substantially reproduce the original media content 110 in a viewable form which is provided to one or more of the displaying systems 168A-168C. For example, encryption 126 and compression 124 applied by the preparation processor 118 is finally removed, however, any latent modification, undetectable to viewers (e.g., watermarking 122) is left intact. In one or more embodiments, a display processor 170 prevents storage of the decrypted media content in any media, whether in the storage device 166 or otherwise. In addition, the media content 110 can be communicated to the displaying systems 168A-168C over an independently encrypted connection, such as on a gigabit LAN 172.

All of the cinema equipment employed in the invention can be collectively referred to as in-cinema equipment (ICE). As described above, the in-cinema equipment receives, stores and plays out the content or source video. The ICE can provide for the delivery of digital content (feature length movies, advertisements, trailer, and live content) via satellite, with a secondary method via DVD, harddrive or other suitable digital storage medium, and allows play out of the content through a digital projector. In addition, the ICE includes the ability to perform logging of data, remote maintenance and monitoring.

In a typical satellite based embodiment, the displaying entities each have installed an approximately 1.8 m diameter satellite receiver antenna, pointed at the satellite and transponder for receipt of the broadcast downlink. The satellite receive antenna is capable of receiving either horizontal or vertical polarized signals. It then feeds the signal to the DVB cache receiver.

The satellite cache receiver 154 receives and decodes the DVB broadcast stream comprising MPEG2 over IP data or straight MPEG2. The receiver 154 strips the IP data from the DVB stream and, if authorized by the transmission security server at the NOC, it decrypts the data. The receiver 154 can be equipped with a smart card, which upon receipt of the proper key, will enable the transmission decryption (the second layer). The receiver 154 then proceeds with forward error correction and checks for errors and corrects them when possible. The receiver 154 notifies the NOC using a terrestrial back channel whether the data are intact or whether there are uncorrectable errors. In the latter case, the NOC will retransmit an equivalent amount of redundant data for the receiver 154 to reconstruct error-free files (content could consist of multiple files). Once the content is corrected, it is stored on the cache. Upon a command from the NOC, the receiver delivers the content to the play-out server (e.g., the processing system 164) over an ETHERNET connection.

Once the content is received, the play out server will create a new title and update the play list accordingly. The content is stored encrypted (the first layer). At the programmed play-out time, the encrypted content will be decrypted (removal of the first layer), decoded (MPEG-2 decompression and audio decompression), and re-encrypted to be streamed securely over the last link to the digital projector (e.g., a SMPTE 292 connection). Other content such as trailers, advertisement, will be decoded and streamed to the projector without encryption. A play list can contain both encrypted and unencrypted content.

In one embodiment, the ICE can come in two general configurations using three different play-out servers, the AVICA FILMSTORE server, the GRASSVALLEY server and the EVS server.

At least one cinema grade digital projector 168 is also used at each user system 108. For example, the TEXAS INSTRUMENTS (TI) DLP CINEMA (digital light prcessing-cinema grade) MARK VII projector can be utilized in this architecture. Integrated in the projector is the decryption chip, which decrypts video on the fly. Unencrypted content can be projected directly through the projector.

The management or “admin” server provides a single point of external access for the ICE. This device can be built into the processing system 164 or operate as separate unit which controls the processing system 164 (play out server). For example, it can enable remote management from the NOC via a 56 kbps channel. It is also responsible for logging operations data from the ICE hardware and software, and for monitoring the health and status of the various ICE elements.

FIG. 2 is a functional block diagram of a computer system 200 that can be used to perform the operations of the media preparation processor 116 and processing system 164. Embodiments of the invention are typically implemented using a computer 200, which generally includes, inter alia, a display device 202, data storage devices 204, cursor control devices 206, and other devices. Those skilled in the art will recognize that any combination of the above components, or any number of different components, peripherals, and other devices, may be used with the computer 100.

Programs executing on the computer 200 (such as an operating system) are comprised of instructions which, when read and executed by the computer 200, causes the computer 200 to perform the steps necessary to implement and/or use the present invention. Computer programs and/or operating instructions may also be tangibly embodied in a memory and/or data communications devices of the computer, thereby making a computer program product or article of manufacture according to the invention. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

2.0 Bandwidth Efficient Modulation

In order to improve operation of the digital satellite cinema system discussed above, bandwidth efficient modulation (BEM) techniques (such as used in terrestrial fiber) can be applied to uplinks and downlinks to the displaying entities 108. Such BEM techniques require more code to noise (C/N) link margin than other typical modulations, e.g. higher order modulations than quadrature phase shift keying (QPSK). It is estimated that use of these techniques can result in approximately 5 to 1 compression of bandwidth (BW) or time, e.g. 1 bit/Hz/second to 5 bits/Hz/second.

For example, in trunking systems BEM optimizes capacity. Some of the BEM techniques that can be applied in the digital cinema system of the present invention include forward error control coding, pulse shaping, adaptive receive equalization and non-linear and linear predistortion. Some of the enabling capabilities for BEM in the digital cinema system include spectral containment, forward error correction and distortion mitigation. Some of the challenges in implementation include power and spectral limitations, nonlinear high power amplifiers and band limiting and linear hardware distortions. With increased bandwidth efficiency, e.g. higher order modulations, sensitivity to distortions increases to surpass the increase in noise sensitivity.

The various BEM techniques can be applied to QPSK modulation to yield approximately 1 bps/HZ applying both forward error control coding and pulse shaping. An eight phase shift keying (8PSK) modulation can produce approximately 2 bps/Hz with the addition of adaptive receive equalization in addition to forward error control coding and pulse shaping. A sixteen quadrature amplitude modulation (16 QAM) can yield approximately 3 bps/Hz by also adding a nonlinear predistortion technique. In a satellite implementation, the impact of nonlinear high power amplifiers becomes significant somewhere between 2 bps/Hz and 3 bps/Hz. A sixty-four quadrature amplitude modulation (64QAM) can yield approximately 5 bps/Hz by with the further addition of linear predistortion over the other BEM techniques.

In an exemplary system embodiment of the present invention, as described above, a file transfer application is used to transfer large video files (e.g. movie files up to approximately three hours in length). These large video files are cinema quality and can be used with a cinema-sized screen at a resolution exceeding 1920×1024 and 24 bit color per pixel at a 24 frame per second (fps) rate. In one example, a digital projector which performs at a resolution of 1280×1024 and 24 bit color per pixel at 24 fps can be used. The digital network which supports the system can utilize Internet protocol (IP) over a digital video broadcasting (DVB) compliant transport stream. Security for the transmitted video can be implemented in multiple layers. For example, a first layer can comprise content encryption at the post production level prior to delivery of the video to the satellite uplink. A second layer of encryption can be applied at transmission, e.g. performed at the IP level rather than the DVB level. This approach would minimize the security overhead in the transmission phase. As previously discussed, embodiments of the present invention use BEM techniques to maximize the video delivery.

Software at the network operations center (e.g., in a distribution server) can be used to implement the IP based multicasting. The software can insert protection packets at the network operations center uplink for the correction of errors at the exhibition systems. The protection packets received intact can be used to correct any packets within the file. This is unlike CRC error checks that are associated to specific packets. This improves the satellite bandwidth efficiency of the system. Error correction overhead is optimized to minimize the need for retransmissions.

A typical satellite link closure for a digital cinema system can be achieved with relatively modest hardware and transmission requirements. For example, a 1.8 m diameter receive antenna would be disposed at each exhibitor system (theater). A quasi-error free DVB link, as discussed above, would be used. Rain availability of approximately 99.90% or better to the exhibitor systems would assure transmission at a reasonable confidence level. A QPSK modem can be used to yield a data rate of approximately 34.8 Mbps through a 27 MHz transponder through an optimized satellite link. The optimized satellite link can employ concatenated forward error correction coding. For example, a Reed Solomon rate of 188/204, a DVB standard can be used along with a convolutional encoding rate of ⅞. The coded channel data rate or chip rate is approximately 43.2 Mbps. QPSK modulation yields a symbol data rate of approximately 21.60 Msps.

Embodiments of the present invention utilize a modem that includes upgraded software to facilitate bandwidth efficient modulation. The available data rate will increase over the typical satellite link to up to and exceeding 60 Mbps using a 27 MHz wide transponder.

3.0 System Security

System security for a typical embodiment of the invention utilizes a two layer scheme. The first layer provides end-to-end content encryption. The second layer provides the transmission encryption.

In the first layer, the content is encrypted at the studio production house (e.g., in the preparation server 116) and stored encrypted at the cinema server (e.g., storage device 166 of processing system 164 at the user system 108). When ready for playout, the cinema's play out server decrypts, decompresses and re-encrypts (link encryption) content prior to transferring it to the digital projector 168. The digital projector 168 will decrypt incoming encrypted content on the fly.

The end-to-end content security encryption can be provided by a software implementation of the Advanced Encryption Standard (AES) into the digital production house's and the cinema's servers. The link encryption security is provided by a software/hardware implementation between the cinema's servers and digital projectors.

The first layer can utilize a key management and distribution system based on constructive key management, an architecture where the key is constructed from multiple components, token, keys, hardware. One suitable exemplary product is Constructive Key Management (CKM) software by TECSEC. The CKM server software is installed at the NOC and at the exhibitor's play out servers. The CKM software allows the NOC to create authorization tokens for distribution to digital production facilities and intended exhibitor systems. Once the tokens are received at the clients, authorized users (digital production facilities and exhibitors play out servers) can encrypt or decrypt the digital content. The clients CKM software agents will construct (create) a key when needed for encryption or decryption and destroy the key when no longer needed by the encryption/decryption engine.

Conditional Access is applied to the tokens at the NOC using the CKM software. This consists of digital content IDs (movie IDs), duration of specific encryption/decryption keys, and any other information determined important to customers. These conditions can be updated over the back channel as needed.

The second layer provides the transmission encryption. With the transmission encryption, only authorized users will be able to decrypt the link and receive the signal (which still includes the first layer security). The NOC is responsible for authorizing receiving sites that are on the distribution list. To achieve this, the NOC distributes conditional access key components to the proper receiving sites, which are equipped with Smart Cards for strong authentication. The transmission encryption security can be provided by the Irdeto conditional access software/hardware between the NOC and the exhibitor's satellite receivers.

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. A system comprising:
a distribution entity transmitting a content data to at least one user system for receiving the transmitted content data and presenting for exhibition; and
a network operation center for coordinating encryption of the transmitted content data at the distribution entity and decryption of the transmitted content data at the at least one user system;
wherein the content data is transmitted using one or more bandwidth efficient modulation (BEM) techniques selected from the group comprising forward error control coding, pulse shaping, adaptive receive equalization, nonlinear predistortion and linear predistortion.

2. The system of claim 1, wherein the content data comprises video data.

3. The system of claim 1, wherein the content data is transmitted via satellite broadcast to more than one user system.

4. The system of claim 1, wherein the video source is transmitted via satellite at a data rate sufficient to allow the content data to be played at the at least one user system in real time.

5. The system of claim 1, wherein the content data is transmitted via satellite using quadrature phase shift keying (QPSK) modulation and forward error control coding and pulse shaping BEM techniques.

6. The system of claim 1, wherein the content data is transmitted via satellite using eight phase shift keying (8PSK) modulation and forward error control coding, pulse shaping and adaptive receive equalization BEM techniques.

7. The system of claim 1, wherein the content data is transmitted via satellite using a four bit per symbol modulation and forward error control coding, pulse shaping, adaptive receive equalization and nonlinear predistortion BEM techniques.

8. The system of claim 7, wherein the content data is transmitted using sixteen quadrature amplitude modulation (16QAM).

9. The system of claim 1, wherein the content data is transmitted via satellite using a six bit per symbol modulation and forward error control coding, pulse shaping, adaptive receive equalization and nonlinear and linear predistortion BEM techniques.

10. The system of claim 9, wherein the content data is transmitted using sixty-four quadrature amplitude modulation (64QAM).

11. The system of claim 1, wherein the content data comprises at least cinema quality video.

12. The system of claim 1, wherein at least one decryption key component for decrypting the content data is communicated to the at least one user system from the network operation center.

13. The system of claim 1, wherein the user system includes:
a receiver for receiving and extracting video data from the transmitted content data;
data storage for buffering the video data;
a decryption unit for decrypting the video data;
a decompression unit decompressing the video data; and
a display device for displaying the decrypted and decompressed video data.

14. The system of claim 1, wherein the content data includes file encryption and conditional access encryption.

15. The system of claim 14, wherein the conditional access encryption is decrypted before the content data is stored by the at least one user system and the file encryption is decrypted after the content data is stored but before the content data is presented by the at least one user system.

16. A method comprising the steps of:
transmitting a content data from a distribution entity;
receiving and presenting the transmitted content data with at least one user system; and
coordinating encryption of the transmitted content data at the distribution entity and decryption of the transmitted content data at the at least one user system with a network operation center;
wherein the content data is transmitted using one or more bandwidth efficient modulation (BEM) techniques selected from the group comprising forward error control coding, pulse shaping, adaptive receive equalization, nonlinear predistortion and linear predistortion.

17. The method of claim 16, wherein the content data comprises video data.

18. The method of claim 16, wherein the content data is transmitted via satellite broadcast to more than one user system.

19. The method of claim 16, wherein the content data is transmitted via satellite at a data rate sufficient to allow the content data to be played at the at least one user system in real time.

20. The method of claim 16, wherein the content data is transmitted via satellite using quadrature phase shift keying (QPSK) modulation and forward error control coding and pulse shaping BEM techniques.

21. The method of claim 16, wherein the content data is transmitted via satellite using eight phase shift keying (8PSK) modulation and forward error control coding, pulse shaping and adaptive receive equalization BEM techniques.

22. The method of claim 16, wherein the content data is transmitted via satellite using a four bit per symbol modulation and forward error control coding, pulse shaping, adaptive receive equalization and nonlinear predistortion BEM techniques.

23. The method of claim 22, wherein the content data is transmitted using sixteen quadrature amplitude modulation (16QAM).

24. The method of claim 16, wherein the content data is transmitted via satellite using a six bit per symbol modulation and forward error control coding, pulse shaping, adaptive receive equalization and nonlinear and linear predistortion BEM techniques.

25. The method of claim 24, wherein the content data is transmitted using sixty-four quadrature amplitude modulation (64QAM).

26. The method of claim 16, wherein the content data comprises at least cinema quality video.

27. The method of claim 16, wherein at least one decryption key component for decrypting the content data is communicated to the at least one user system from the network operation center.

28. The method of claim 16, wherein the user system includes:
a receiver for receiving and extracting video data from the transmitted content data;
data storage for buffering the video data;
a decryption unit for decrypting the video data;
a decompression unit decompressing the video data; and
a display device for displaying the decrypted and decompressed video data.

29. The method of claim 16, wherein the content data includes file encryption and conditional access encryption.

30. The method of claim 29, wherein the conditional access encryption is decrypted before the content data is stored by the exhibitor system and the file encryption is decrypted after the content data is stored but before the content data is presented by the at least one user system.
